(19) United States
(12) Patent Application Publication
(10) Pub. No.: US 2026/0297765 A1
(43) Pub. Date: Oct. 1, 2026

(54) SYSTEMS AND METHODS FOR CONVERTING CO2 TO ONE OR MORE MULTICARBON PRODUCTS

(71) Applicant: Rensselaer Polytechnic Institute, Troy, NY (US)

(72) Inventor: VIDHYA CHAKRAPANI, Albany, NY (US)

(73) Assignee: Rensselaer Polytechnic Institute, Troy, NY (US)

(21) Appl. No.: 19/481,781

(22) PCT Filed: May 6, 2024
(86) PCT No.: PCT/US2024/027959

§ 371 Date: Nov. 5, 2025

Related U.S. Application Data
(60) Provisional application No. 63/464,373, filed on May 5, 2023.
(60) Provisional application No. 63/641,993, filed on May 3, 2024.

(51) Int. Cl. C25B 3/26; C25B 3/07; C25B 9/17; C25B 11/077

(52) U.S. Cl. CPC C25B 3/26; C25B 3/07; C25B 9/17; C25B 11/077

(57) ABSTRACT

The systems and methods convert CO₂ to one or more multicarbon products using a green rust material in spontaneous and electrocatalytic reactions. In an embodiment, a first electrode that includes a green rust material and a second electrode are contacted by an electrolyte, where the first and second electrodes are separated by a proton exchange membrane. For electrocatalytic reactions, a potential difference is applied across the electrodes. Multicarbon products can be removed from the electrolyte in contact with the green rust material after the desired contact period.

### CROSS-REFERENCE TO RELATED APPLICATIONS

This application claims the benefit of U.S. Provisional Patent Application No. 63/464,373, filed May 5, 2023, and U.S. Provisional Patent Application No. 63/641,993 filed May 3, 2024, which are incorporated by reference as if disclosed herein in their entireties.

### BACKGROUND

The conversion of greenhouse gases such as CO₂ into green fuels and valuable chemicals is of paramount interest to achieve a decarbonized future. Direct low-temperature conversion technologies, such as electrocatalysis and photocatalysis, are very attractive because they can potentially produce a range of easy-to-store high-value liquid chemicals in a cleaner and more efficient way because activation energy barriers, stabilization of the reaction intermediates, and the nature of the final products can all be controlled and modulated through the electrode potential without requiring high-temperature catalysis. In reality, the formation of multicarbon products, even with a C greater than 2, is challenging because this involves multiple coupled electron and proton transfer steps and requires the difficult C—C coupling between similarly charged repulsive reactive intermediates. Copper and its alloys can generate C2 and C3 alkanes, alcohols, ketones, and aldehydes at significant rates. However, the selectivity of pure copper catalysts is often poor, leading to a broad distribution of products including significant unnecessary side reactions of H₂. Without wishing to be bound by theory, this is because a high overvoltage (|η|=0.8-1.0 V) is required to overcome repulsive coupling on charged intermediates, leading to a loss of selectivity. Another challenge with copper catalysts is its preference for multicarbon gaseous products such as alkanes.

Similar challenges exist for non-copper electrocatalysts for producing multicarbon liquid products. Nitrogen-doped carbon and diamond are non-Cu catalysts reported for the conversion of CO₂ to ethanol at 16-93% selectivity but require overvoltages close to −1.0 V.

What is desired, therefore, is a material useful for converting CO₂ to multicarbon products with improved selectivity, efficiency, and/or ease of use.

### SUMMARY

Some embodiments of the present technology are directed to systems for converting CO₂ to one or more multicarbon products using a green rust material under both natural (unassisted) and electrochemical conditions. In some embodiments, a first electrode comprising a quantity of green rust material is positioned in a container comprising a first volume for holding a first electrolyte so that the green rust is in contact with the electrolyte. A second electrode is arranged in the container to form, together with the first electrode, electrical terminals of an electrolytic cell. A source of CO₂ is coupled to the container and adapted to supply CO₂ to the first volume. Without wishing to be bound by theory, in some embodiments, the green rust material acts as a reducing agent or reductant and in some embodiments, the green rust material acts as a catalyst.

In some embodiments, a source of potential is connected to the first and second electrodes and is adapted to apply a potential difference across the electrodes for electrochemical conversion of CO₂.

Some embodiments of the present technology are directed to methods for converting CO₂ to one or more multicarbon products. Such methods include supplying CO₂ to an electrolyte, contacting a first electrode comprising a quantity of a green rust material with the electrolyte; and removing the electrolyte after contacting the first electrode for a contact period. Some embodiments include contacting a second electrode with the electrolyte and separating the first electrode from the second electrode with a proton exchange membrane. Electrochemical methods include the step of applying a potential difference across the first and second electrodes.

Some embodiments of the present technology result in multicarbon liquid products, such as ethanol, methanol, acetone, acetate, acetaldehyde, formate and others.

Various embodiments of the technology will now be described with reference to the drawings.

### BRIEF DESCRIPTION OF THE DRAWINGS

The drawings show embodiments of the disclosed subject matter for the purpose of illustrating the technology. However, it should be understood that the present application is not limited to the precise arrangements and instrumentalities shown in the drawings, wherein:

FIG. 1 shows a schematic view of a system according to one embodiment of the present technology.

FIG. 2 shows a schematic representation of the crystallographic structure of layered green rust with variable interlayer spacing.

FIG. 3 shows a schematic view of a system for forming a green rust material according to one embodiment of the present technology.

FIG. 4 shows the Raman spectrum of green rust formed in connection with an embodiment of the present technology.

FIG. 5 shows the multiplet peak fitting analysis of the core-level Fe 2p_{3/2} XPS spectrum of green rust film using the multiplet peaks of Fe^{II} and Fe^{III} in connection with an embodiment of the present technology.

FIG. 6a shows a chart of the ¹H-NMR spectrum of pH=9.5 electrolyte measured after CO₂ conversion at the green rust electrode without the application of an external bias in connection with an embodiment of the present technology.

FIG. 6b shows a chart of the concentration analysis of CO₂ conversion products formed on green rust substrates exposed to CO₂-saturated electrolyte for varying durations of time in connection with an embodiment of the present technology.

FIG. 7a shows a chart of a linear sweep voltammograms of green rust films in CO₂-saturated 0.5 M KHCO₃ electrolyte at pH=7.3 and pH=9.5 in connection with an embodiment of the present technology.

FIG. 7b shows a chart of a ¹H-NMR spectrum of pH=9.5 electrolyte measured after CO₂ conversion polarization potential of −0.2V vs. RHE for various durations in connection with an embodiment of the present technology.

FIG. 7c shows a chart of the concentration of the CO₂ conversion products obtained in an embodiment of the present technology.

FIG. 7d shows a chart of the Faradaic efficiency of the CO₂ conversion products obtained in an embodiment of the present technology.

FIG. 8a shows a chart of the chronoamperometric curve recorded on green rust during CO₂ reduction at various potentials in connection with an embodiment of the present technology.

FIG. 8b shows a chart of a ¹H-NMR spectrum of pH=7.3 electrolyte measured after CO₂ conversion polarization potential of −0.2V vs. RHE for various durations in connection with an embodiment of the present technology.

FIG. 8c shows a chart of the concentration of the CO₂ conversion products obtained in an embodiment of the present technology.

FIG. 8d shows a chart of the Faradaic efficiency of the CO₂ conversion products obtained in an embodiment of the present technology.

### DETAILED DESCRIPTION

One or more embodiments of the present technology are directed to a system for converting CO₂ to one or more multicarbon products. According to a first embodiment, the system 100 comprises a container 101 that includes a first volume 102 adapted to hold a first electrolyte 103. The container comprises any suitable structure for containing the electrolyte and performing electrochemical processes.

The system further comprises a first electrode 104. In some embodiments, the first electrode 104 is formed of steel. In other embodiments, the first electrode is formed of iron or other iron-containing alloys. The first electrode 104 includes a quantity of a green rust catalyst 105. The first electrode is positioned in the container so that the green rust material 105 is in contact with the first electrolyte 103. In some embodiments, substantially all of the first electrode 104 that is in contact with the electrolyte includes the green rust material. In other embodiments, only a portion of the first electrode 104 that is in contact with the electrolyte includes the green rust material. In other words, in some embodiments, the green rust material covers less than all of the surface of the first electrode that is in contact with the electrolyte. In other embodiments, substantially all of the surface of the first electrode that is in contact with the electrolyte comprises the green rust material.

In some embodiments, the first electrode 104 comprising the material 105 is submerged within a bath of electrolyte contained in the first volume 102. In some embodiments, the container is a type of tank. In other embodiments, the container is in the form of a flow conduit such that first electrode 104 is positioned in the conduit so that the green rust material is contacted by electrolyte flowing through the conduit.

In some embodiments, the first electrolyte 103 comprises KHCO₃. In some embodiments, the first electrolyte 103 comprises 0.5 M KHCO₃. In some embodiments, the electrolyte has a pH of about 9.5. In some embodiments, as described below, continuous purging of CO₂ into the electrolyte reduces the electrolyte pH, so periodic addition of 10 M KOH was done to maintain the pH at about 9.5. In some embodiments, the first electrolyte has a pH of about 7.7. In some embodiments, the first electrolyte has a pH of about 7.4. In some embodiments, the first electrolyte has a pH of about 8.2. In some embodiments, the first electrolyte has a pH of about 7.3. In some embodiments, the first electrolyte has a pH of about 8.3. In some embodiments, the first electrolyte has a pH between about 7.3 and about 9.5. In some embodiments, the first electrolyte has a pH of between about 7.4 and about 8.2. In some embodiments, the first electrolyte has a pH of between about 9.2 and about 9.8. In some embodiments, the first electrolyte has a pH of between about 9.0 and about 10.0. In some embodiments, the first electrolyte has a pH of between about 9.5 and about 10.8. In some embodiments, the first electrolyte has a pH of between about 7.0 and about 7.6. In some embodiments, the first electrolyte has a pH of between about 6.8 and about 7.8. In some embodiments, the first electrolyte has a pH of between about 7.3 and about 8.3.

In some embodiments, the surface-to-volume (S/V) ratio for the geometric surface area of the portion of the first electrode 104 that includes green rust material 105 to the volume of first electrolyte 103 is about 1.55 cm⁻¹. In some embodiments, the S/V ratio is in the range of about 1.4 to about 1.7. In some embodiments the S/V ratio is in the range of about 1.1 to about 2.0. In some embodiments, the S/V ratio is below 1.0.

The system 100 further comprises a second electrode 106. The second electrode 106 is arranged in the container 101 to form, together with the first electrode 104, electrical terminals of an electrolytic cell. In some embodiments, the second electrode 106 comprises platinum. In some embodiments, the second electrode 106 comprises platinum mesh. In some embodiments, the second electrode is submerged in electrolyte 103′ that is the same as the first electrolyte 103. In some embodiments, the electrolyte 103′ comprises 0.5 M KHCO₃.

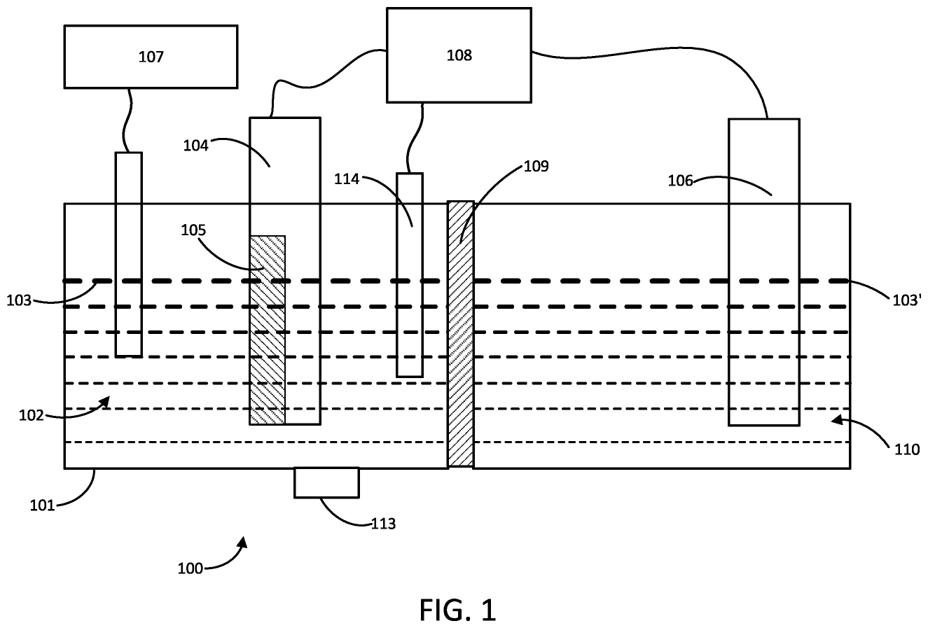

The system further includes a source 107 of CO₂ coupled to the container and adapted to supply CO₂ to the first volume 102. In some embodiments, the CO₂ source is adapted to supply gaseous CO₂ in a continuous manner to the first volume 102 of the container 101. In some embodiments, the supply of CO₂ enters the first volume 102 from a lower or bottom region of the first volume. In other embodiments, the source is arranged so that the CO₂ outlet from the source is submerged in the electrolyte 103 and suspended at a distance from the walls of the container, as shown in FIG. 1.

In some embodiments, the electrolyte 103 has been subjected to a CO₂ purging process prior to contact with the material 105. In some embodiments, the electrolyte 103 was purged with CO₂ for 15 minutes prior to contact with the material 105. In some embodiments, the electrolyte 103 is saturated with CO₂ prior to contact with the green rust material.

In some embodiments, a source of potential 108 is connected to the first and second electrodes 104 and 106 and is adapted to apply an electrical potential difference across the electrodes. Such embodiments can perform electrocatalytic conversion of CO₂ to multicarbon products. In some embodiments, a reference electrode 114 is also connected to the system and submerged in the first electrolyte 103. In some embodiments, the reference electrode is a saturated calomel electrode.

In some embodiments, the source of potential is adapted to apply a voltage of between about −0.15 V and about −0.35 V across the first and second electrodes, where the potential was measured against the reference electrode and converted to the reversible hydrogen electrode (RHE). In some embodiments, the applied voltage is about −0.15 V vs. RHE across the first and second electrodes. In some embodiments, the applied voltage is about −0.2 V vs. RHE across the first and second electrodes. In some embodiments, the applied voltage is about −0.35 V vs. RHE across the first and second electrodes. In some embodiments, the applied voltage is between about −0.01 and −0.2 V vs. RHE.

In some embodiments, the system 100 comprises a proton exchange membrane 109 disposed in the container 101 and separating the first volume 102 from a second volume 110 in which the second electrode 106 is arranged. In some embodiments, the container 101 comprises an H-cell—a two-compartment electrochemical cell. In some embodiments, the system 100 uses a Nafion 117 membrane manufactured by MTI Corp.

In some embodiments, the container 101 includes an outlet port 113, out of which the first electrolyte 103 can be extracted from the container 101. In some embodiments, the technology includes isolating one or more multicarbon products from the electrolyte extracted from the container.

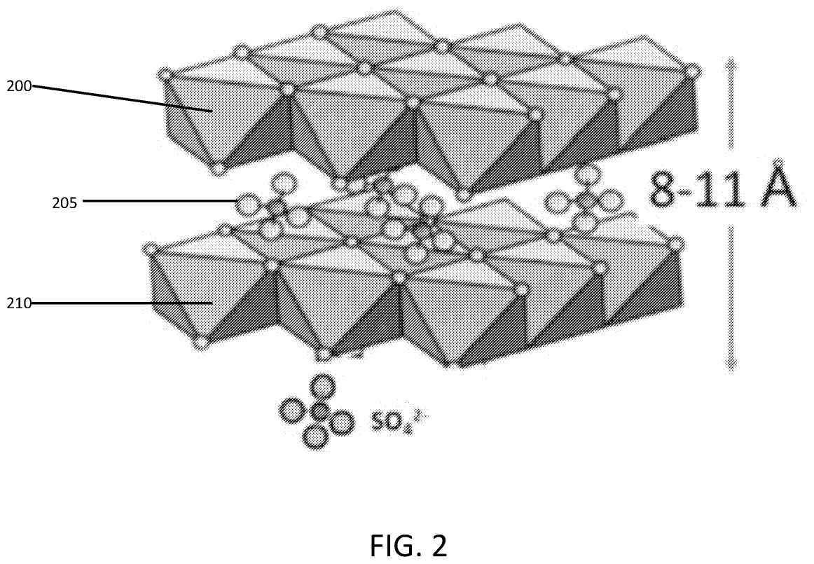

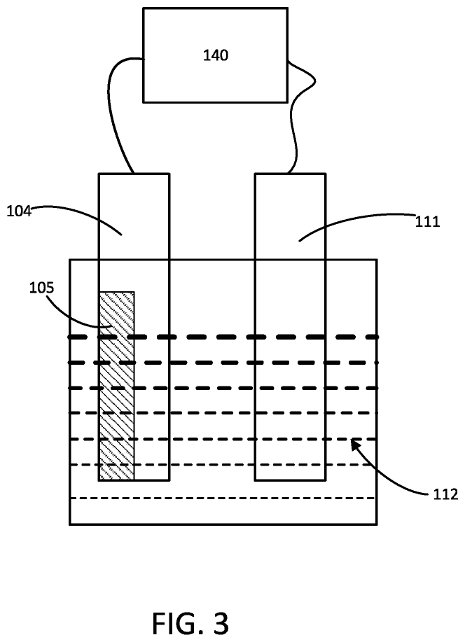

As is known in the art, green rust is a Fe^{II}—Fe^{III} oxyhydroxide compound that is known to form as a result of pitting corrosion of iron and iron alloys under anaerobic conditions. It comprises a layered structure as shown in FIG. 2 and has the general formula for its chemical composition as [(Fe^{II})₁₋ₓFeₓ^{III}(OH)₂]^{x+}[x/nAⁿ⁻·m/nH₂O]^{x-}, where Aⁿ⁻ is SO₄²⁻, CO₃²⁻, Cl⁻ etc. In the schematic illustration in FIG. 2, two crystalline layers 200 and 210 and one anion layer is shown.

In some embodiments, a green rust material 105 is formed on the first electrode 104 by contacting the first electrode 104 and a counter electrode 111 with a second electrolyte 112 and applying a potential difference across the first electrode and the counter electrode 111. In some embodiments, N₂ is supplied to the second electrolyte 112. In some embodiments the second electrolyte comprises NaHCO₃ and N₂ is supplied via a purging process. In some embodiments the pH of the NaHCO₃ is adjusted to about 9.5 by adding NaOH.

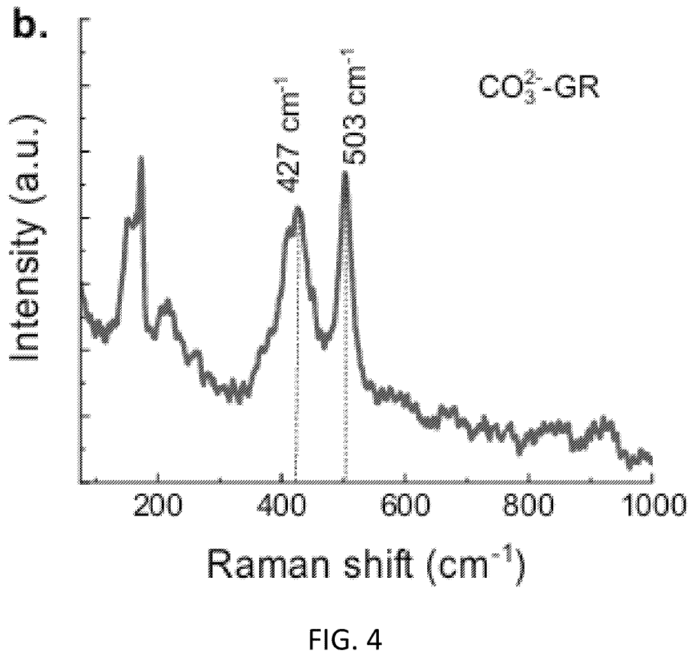

In some embodiments, the green rust material comprises at least one crystalline layer and the at least one crystalline layer comprises Fe^{II}—OH and Fe^{III}—OH. FIG. 4 shows the Raman spectrum of a green rust film created on an electrode according to one embodiment of this technology. The film shows peaks only at 427 cm⁻¹ and 503 cm⁻¹ wavenumbers that are characteristic of the Fe^{II}—OH and Fe^{III}—OH stretching vibrations of mixed-valent green rust. Other phases of FeOx may be present in other embodiments of the green rust material. In some embodiments, at least one crystalline layer of the green rust material consists essentially of Fe^{II}—OH and Fe^{III}—OH. In some embodiments, the at least one crystalline layer of the green rust material consists of Fe^{II}—OH and Fe^{III}—OH. When green rust is exposed to air, for example for 10 or more hours, the green rust will begin to transform to other FeOₓ phases, such as hematite. Thus, in some embodiments, as synthesized and prior to exposure to air, the at least one crystalline layer of the green rust material consists essentially of Fe^{II}—OH and Fe^{III}—OH. In other embodiments, the at least one crystalline layer of the green rust material comprises additional FeOₓ phases.

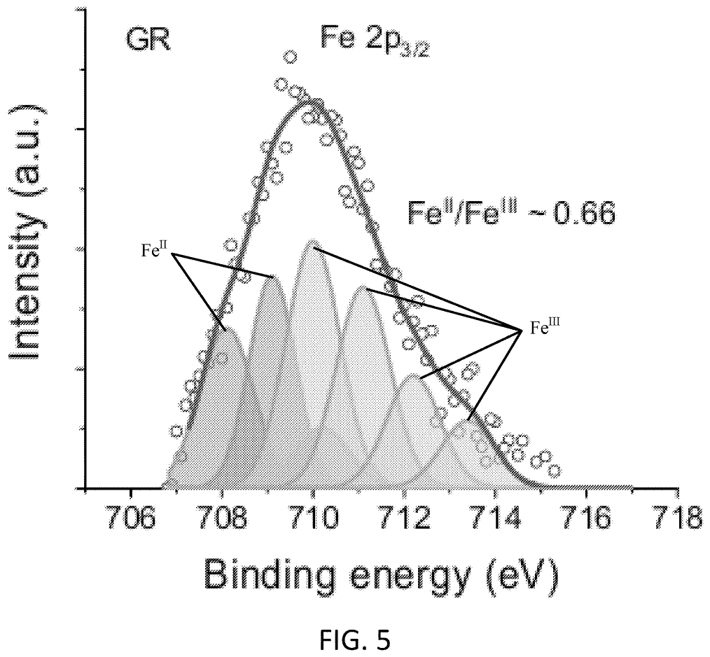

In some embodiments, the ratio of Fe^{II}—OH to Fe^{III}—OH in the material is between about 0.5 and about 1.0. In some embodiments, the ratio of Fe^{II}—OH to Fe^{III}—OH is about 0.66. FIG. 5 shows the multiplet peak fitting analysis of the core-level Fe 2p_{3/2} XPS spectrum of carbonate-GR film using the multiplet peaks of Fe^{II} and Fe^{III}.

According to an additional embodiment of the present technology, a method for converting CO₂ to one or more multicarbon products is provided. In one embodiment, the method comprises: supplying CO₂ to an electrolyte; contacting a first electrode comprising a quantity of a green rust material with the electrolyte; and removing the electrolyte after contacting the first electrode for a contact period. In some embodiments, the electrolyte is saturated with CO₂.

In some embodiments, the method further comprises contacting a second electrode with the electrolyte and separating the first electrode from the second electrode with a proton exchange membrane. In embodiments such as this in which no potential bias is applied to the electrodes, CO₂ reduction (i.e., conversion) occurs spontaneously. In some embodiments, ethanol, acetaldehyde, acetone, and/or acetate will form in the CO₂-supplied electrolyte.

Some embodiments of a method for converting CO₂ to one or more multicarbon products further comprise applying a potential difference across the first and second electrodes. In some embodiments, this step comprises applying a voltage between about −0.15 V and about −0.35 V across the first and second electrodes. In some embodiments, ethanol, methanol, formate, acetate, and/or acetone form in the CO₂-supplied electrolyte after application of the potential difference.

In some embodiments of the method, the green rust material comprises at least one crystalline layer and the at least one crystalline layer comprises Fe^{II}—OH and Fe^{III}—OH. In some embodiments, the ratio of Fe^{II}—OH to Fe^{III}—OH in the material is between about 0.5 and 1.0.

In some embodiments, the electrolyte comprises KHCO₃. In some embodiments, the second electrode comprises platinum.

In some embodiments, the contact period is between about 10 minutes and 60 minutes. In some embodiments the contact period is about 10 minutes, at which time the electrolyte is extracted from the container for further processing. In some embodiments, the contact period is about 20 minutes. In some embodiments, the contact period is about 30 minutes. In some embodiments, the contact period is about 40 minutes. In some embodiments, the contact period is about 50 minutes. In some embodiments, the contact period is about 60 minutes. In some embodiments, the contact period is between about 5 minutes and about 120 minutes.

As described above, in some embodiments the method further comprises forming the green rust material by: supplying N₂ to a second electrolyte; contacting the first electrode and a counter electrode with the second electrolyte; and applying a potential difference across the first electrode and the counter electrode; wherein the second electrolyte comprises NaHCO₃ adjusted to a pH of about 9.5 by adding NaOH.

### Example: Spontaneous CO₂ Reduction

In one exemplary embodiment, a commercially available steel sheet of 2 cm×15.5 cm was sequentially cleaned with soapy water, then deionized water, and then electrochemically with the application of −1 V cathodic bias with respect to the standard calomel electrode (SCE) for 4000 seconds in an electrolyte of 0.5 M NaHCO₃ adjusted to a pH of 9.5 using 10 M NaOH. In this example, a platinum mesh electrode served as the counter electrode, and the reaction was carried out in a single-compartment glass cell. Subsequently, the cleaned steel surface was submerged in N₂-purged electrolyte of 0.5 M NaHCO₃ adjusted to a pH of 9.5 using 10 M NaOH. Green rust formed on the steel sheet through cyclic voltammetry scans between −1 V and −0.2 V at a scan rate of 100 mV/sec for 50 cycles. The steel sheet took on a green color.

The GR-coated steel sheet was used as a working electrode that had a geometric surface area(S) of 62 cm² with respect to the electrolyte volume (V) of 40 ml, for an S/V ratio of 1.55 cm⁻¹. This S/V ratio was chosen to increase the concentration of liquid phase products in the electrolyte and allow for unambiguous and sensitive detection of analytes.

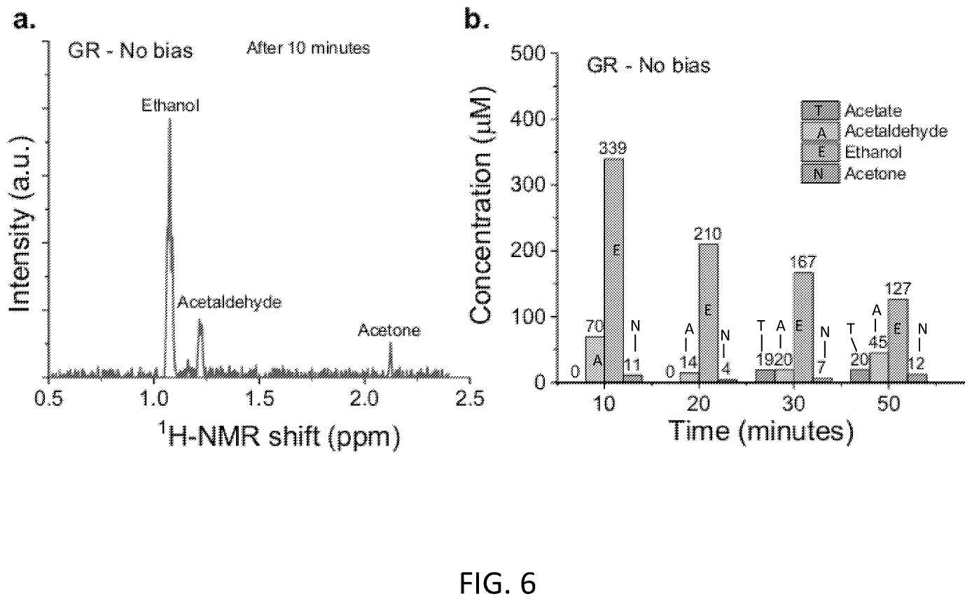

The GR material was exposed to CO₂-saturated 0.5 M KHCO₃ electrolyte of pH=9.5 for varying lengths of time. An H-cell was used without making any electrical connections. Because continuous CO₂ purging leads to a reduction in the electrolyte pH, the pH was maintained at 9.5 by periodic addition of 10 M KOH. A small amount of electrolyte was extracted at various time intervals and its composition was analyzed by quantitative proton nuclear magnetic spectroscopy (q-¹H-NMR). FIG. 6a shows a representative ¹H-NMR spectrum of the CO₂-saturated electrolyte that was exposed to GR without any applied bias for 10 minutes. A strong peak for ethanol (C₂H₅OH), a C₂ compound, can be observed at ~1.1 ppm along with the additional peaks ~1.4 ppm, and ~2.1 ppm corresponding to acetaldehyde (CH₃CHO) and acetone (CH₃COCH₃), respectively. The peak resonance of dimethyl sulfoxide (DMSO), which was added to electrolyte at a concentration of 500 μM as an internal standard to enable quantitative compositional analysis occurs at 2.6 ppm (not shown). Similarly, the background H₂O/D₂O peaks at 4.80 ppm are not shown for the sake of clarity. These results show that GR is capable of activating CO₂ for multi-carbon reduction at room temperature and ambient pressure without requiring any external bias. Here GR functions as a reductant.

FIG. 6b shows the time-dependent changes in electrolyte composition, as determined from the NMR analysis. Maximum production of ~340 μM ethanol along with 70 μM of acetaldehyde and 11 μM of acetone for a total of 421 μM of products occurred within the first 10 minutes of exposure. This corresponds to a maximum production rate of 2520 μmoles L⁻¹ h⁻¹ for the C2 and C3 products without external bias. With a longer exposure time, a significant drop in the ethanol concentration in the electrolyte was observed.

### Example: Electrocatalytic CO₂ Reduction

In another exemplary embodiment, electrocatalytic CO₂ reduction was performed with a green rust as a catalyst using a three-electrode setup housed in an air-tight glass H-cell. The cathode side included the working electrode (GR/Steel substrate, formed as described in the previous example) and a saturated calomel electrode (SCE) as the reference electrode. All potential measured against SCE was later converted to the reversible hydrogen electrode (RHE) scale. A platinum mesh electrode served as the counter electrode on the anode side. The two sides were separated by a proton-exchange Nafion 117 membrane (MTI Corporation) to prevent intermixing of the product stream except for the generated protons. The electrolyte on both sides was 0.5 M KHCO₃. Before starting the process, the electrolyte on the cathode side was purged with CO₂ for 15 minutes, which led to a reduction in the pH of the catholyte from 8.2 to 7.4. CO₂ was continuously bubbled through this solution during the process to avoid depletion. A linear sweep voltammogram of GR was recorded in N₂ and CO₂ purged electrolytes for a comparative study. Catalytic performance was evaluated through potentiostatic measurements, in which a constant cathodic potential was applied to the working electrode for various time intervals. Gas and liquid phase samples were periodically extracted to determine their composition using gas chromatography and ¹H-NMR spectroscopy. The gas phase product was sampled every 20 min using a gastight syringe (Hamilton) using a gas bag. A gas chromatograph (Agilent) equipped with a 5 Å molecular sieve column was used for detection of H₂ and any CO. The total Faradaic efficiency (FE) of the CO₂ reduction to products was determined using the equation:

$$FE ( \% ) = \frac{\begin{matrix}Moles of chemical product ( moles ) \times \\ No . of electrons ( n ) \times 96500 ( \frac{C}{mole} )\end{matrix}}{Amout of charge passed , it ( C )}$$

Here, n is 2, 8, 16, 6, and 12, for the reaction that forms formate, acetate, acetone, methanol, and ethanol, respectively.

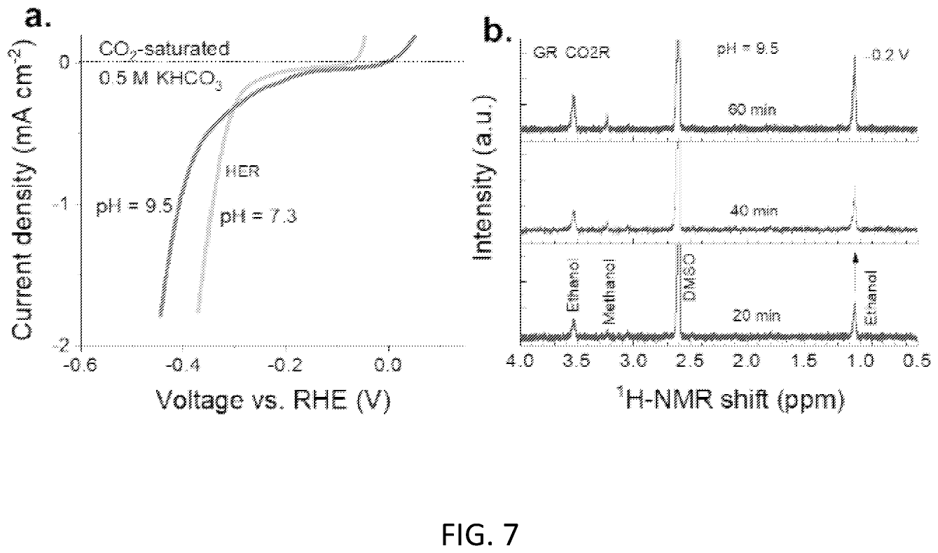

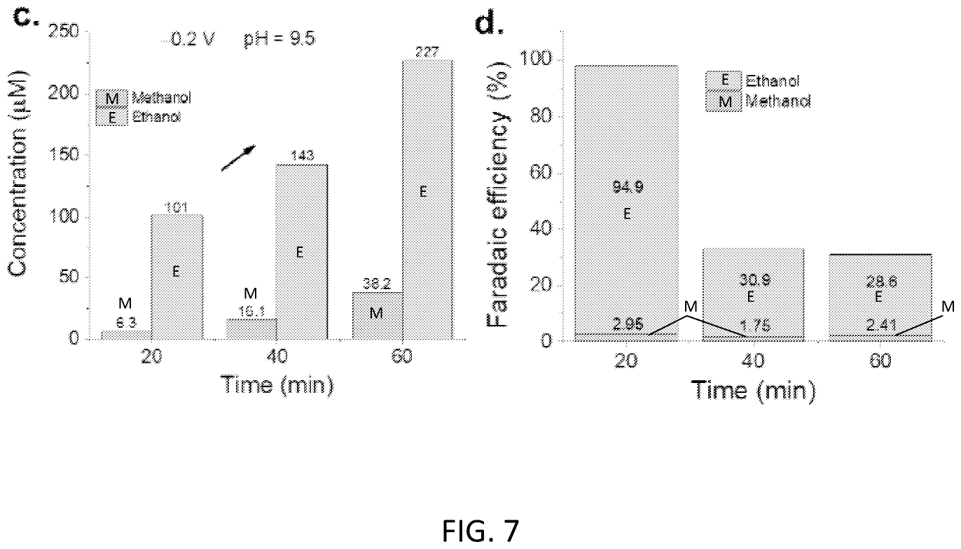

FIG. 7a compares the linear sweep voltammograms of GR obtained under CO₂-saturated 0.5 M KHCO₃ electrolytes of pH=7.3 and pH=9.5. Under both conditions, the sharp increase in reductive current with increasing cathodic polarization with potentials more negative than −0.3 V is due to hydrogen evolution. The onset of H₂ evolution occurs at a more negative potential in the pH=9.5 electrolyte compared to that in pH=7.3. Furthermore, at lower potentials in the range of 0 and −0.2 V, the reduction current of CO₂ is higher in the electrolyte pH=9.5 compared to that measured at pH=7.3. These observations point to the increased stability of GR in a more alkaline environment.

Green rust is most stable in the pH range of 8-11 and is electrochemically formed at a pH of 9.5. Therefore, electrocatalytic CO₂ reduction was performed in CO₂-saturated 0.5 M KHCO₃ whose pH was adjusted to 9.5 using a 10 M KOH solution. To understand how time affects the nature of CO₂ intermediates and product selectivity, a chronoamperometric study was carried out at a constant applied potential of −0.2 V vs. RHE for a period of 120 minutes. The potential was intermittently stopped every 20 minutes to allow the extraction of a small amount of electrolyte whose composition was analyzed by quantitative proton nuclear magnetic spectroscopy (q-¹H-NMR). The table below lists the thermodynamic reduction potentials (Uredox) at pH=7 and the number of electrons (n) required to reduce CO₂ to various liquid products of interest. Using the values of n, the measured concentrations of the products and the total coulombs of charged passed, the total Faradaic efficiency (FE) of the reduction of CO₂ to various products was determined. FIGS. 7b-d summarize the performance of GR under the above conditions.

| | ΔGₜ¹³ | | | |
|---|---|---|---|---|
| Product | (KJ/mol) | Reactions | (U_{redox}) | |
| Formate | −351.04 | CO₂ + 2H⁺ + 2e⁻ → HCOO⁻ + H⁺ | −0.22 | V |
| Methanol | −175.39 | CO₂ + 6H⁺ + 6e⁻ → CH₃OH + H₂O | 0.032 | V |
| Acetate | −369.41 | 2CO₂ + 8H⁺ + 8e⁻ → CH₃COO⁻ + H⁺ + 2H₂O | 0.07 | |
| 2-Propanol | −185.94 | 3CO₂ + 18H⁺ + 18e⁻ → CH₃CH(OH)CH₃ + 5H₂O | 0.1087 | |
| Ethanol | −181.75 | 2CO₂ + 12H⁺ + 12e⁻ → C₂H₅OH + 3H₂O | 0.09 | V |
| Acetone | −161.17 | 3CO₂ + 16H⁺ + 16e⁻ → CH₃COCH₃ + 5H₂O | 0.106 | V |

| | | | |
|---|---|---|---|
| Lactate | −517.81 | 3CO₂ + 12H⁺ + 12e⁻ | 0.0399 |
| | | → CH₃CH(OH)COO⁻ + H⁺ + 3H₂O | |
| Malonate | −624 | 3CO₂ + 8H⁺ + 8e⁻ | −0.109 |
| | | → ⁻OOCCH₂COO⁻ + 2H⁺ + 2H₂O | |
| Glycollate | −530.95 | 2CO₂ + 6H⁺ + 6e⁻ → HOCH₂COO⁻ + H⁺ + H₂O | −0.0355 |
| Pyruvate | −474.63 | 3CO₂ + 10H⁺ + 10e⁻ → CH₃COCOO⁻ + H⁺ + 3H₂O | 0.0032 |
| Glycerol | −477.06 | 3CO₂ + 10H⁺ + 10e⁻ | 0.0057 |
| | | → HOCH₂CH(OH)CH₂OH + 3H₂O | |
| Peracetate | Not known | 2CO₂ + 8H⁺ + 8e⁻ → CH₃COOO⁻ + H⁺ + 2H₂O | |
| Water | −237.18 | | |
| CO2 | −394.36 | | |

As with the case of spontaneous CO₂ reduction, the primary product of the CO₂ reduction in pH=9.5 electrolyte was again ethanol with a 95% FE, which is a high efficiency. The ethanol production rate corresponding to this efficiency was 303 μM h⁻¹ or 13960 μg L⁻¹ h⁻¹ was observed after 20 minutes of polarization at −0.2 V vs. RHE. In addition to ethanol, methanol was the minor secondary product produced at a FE of ~3%. Although the ethanol concentration increased with increasing polarization time up to 60 mins, the FE decreased from 95% to 29% after 1 hour of polarization. This is similar to the trend observed in the example of spontaneous CO₂ reduction.

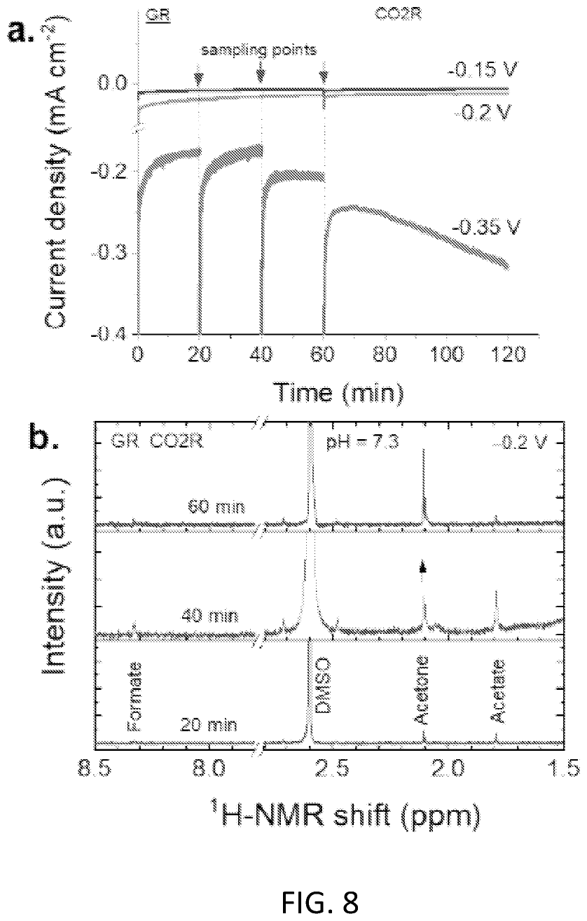

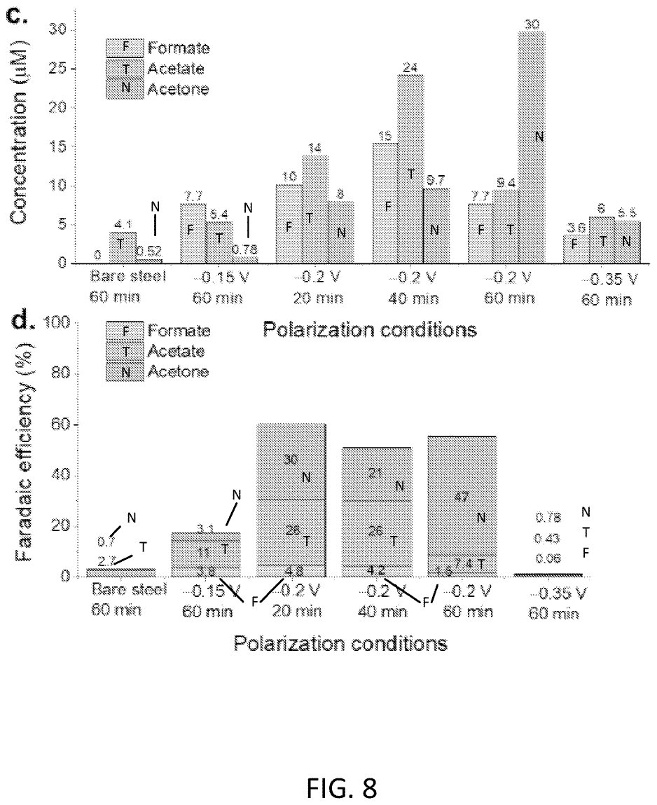

The electrocatalytic activity of GR was also tested under different electrolyte pH. Since the GR is unstable under acidic conditions, the test was performed under a mildly alkaline condition of pH=7.3 obtained after CO₂ saturation of 0.5 M KHCO₃ electrolyte. FIG. 8a shows the chronoamperometric curve of GR with an applied bias of −0.15 V, −0.2 V, and −0.35 V with respect to the reversible hydrogen electrode (RHE). These potentials represent the stable performance range of GR where the evolution of H₂ was minimum and is much lower than the typical operating range of −0.6 V to −1.0 V of copper electrodes for CO₂ conversion in the KHCO₃ electrolyte. The magnitude of the current increases with increasing bias and in each case stabilizes at a nearly steady value after the initial conditioning period in the case of −0.15 V and −0.2 V, indicating the stability of the GR film against the loss of CO₂ activity in these potential ranges. However, when the applied potential was further increased to −0.35 V, a significant evolution of H₂ was observed.

FIG. 8b shows the time-dependent changes in the ¹H-NMR spectrum of the electrolyte during constant electrochemical polarization with −0.2 V bias. In stark contrast to the CO₂ reduction products obtained at pH=9.5, under a more acidic condition, acetone is the dominant product. A strong singlet peak for acetone, a C3 compound (CH₃COCH₃), can be observed at 2.1 ppm, which is seen to increase with increasing time of polarization. Additionally, peaks can also be seen at 1.8 ppm and 8.32 ppm, which correspond to the peaks of acetate/acetic acid (H₃CCOO—/H₃CCOOH), and formate/formic acid (HCOO⁻/HCOOH), respectively. From the quantitative analysis of the ¹H-NMR spectrum, the composition of the electrolytes corresponding to the peak values was determined and is shown in FIG. 8c for various potentials and polarization time. Analysis shows that at pH=7.3, the reduction products are formate, acetate, and acetone regardless of the polarization potential, including on a bare steel substrate. Time-dependent analysis done with a bias of −0.2 V shows that the change in the acetate concentration is parabolic with time, where it increases first with increasing the bias time but decreases with longer bias time. This contrasts with the steady increase in the acetone concentration with time. Without wishing to be bound by theory, this behavior suggests that acetate is an intermediate for the production of acetone. Increasing the polarization potential to −0.35 V led to an overall decrease in the concentration of liquid products and a concomitant increase in the H₂ generation. At a lower polarization potential of −0.15 V, acetate was the dominant product, but its concentration was lower than that produced at −0.2 V.

FIG. 8d shows the Faradaic efficiency of the CO₂ conversion products obtained. The highest FE of 47% for acetone formation was obtained after 60 minutes of polarization at −0.2 V (vs. RHE), which corresponds to an overpotential of just 60 mV if one uses the thermodynamic reduction potential of the CO₂/acetone redox couple of −0.14 V. However, it should be noted that this thermodynamic U_{redox} value corresponds to the case when acetone and CO₂ are present in their standard state, which is 1 M concentration and 1 bar pressure, respectively. Although the partial pressure of CO₂ in the system is close to 1 bar, acetone is not initially present in the system. However, the thermodynamic U_{redox} value can be calculated using the Nernst equation for the maximum concentration of acetone produced in the system (~33 μM), which is −0.113 V. Using this value of U_{redox} gives the overpotential value of ~76 mV, which is a low overpotential for CO₂ conversion to acetone. The FE of 47% at 76 mV overpotential is high for acetone formation.

A maximum FE of ~60% for the conversion of CO₂ to the combined liquid products is observed for a −0.2 V bias. Similarly, the overvoltage used for conversion to formate and acetate was calculated to be 180 mV and 430 mV if one assumes that their standard redox potential adjusted for pKa at pH=7 is −0.02 V and +0.23 V, respectively. The low FE of the GR films seen at more reductive potentials (−0.35 V versus RHE) indicates that the selectivity for the reaction changes with the evolution of H₂. This behavior contrasts with what is observed on copper catalysts, where hydrogen evolution is suppressed and CO₂ conversion is favored at high overpotentials. Without wishing to be bound by theory, these observations indicate that the mechanism of CO₂ conversion on GR may be different from those previously reported for Cu catalysts.

The corrosion resistance of GR was evaluated by measuring the total dissolved Fe content (Fe^{II} and Fe^{III}) in the solution spectrophotometrically using the FerroZine method and using standard solutions of Fe^{II} in 0.5 M KHCO₃. The total colloidal Fe in the electrolyte after 2 hours of polarization was found to be 3 μM, which points to the moderate stability of GR under the investigated potentials. The dissolution was more rapid under higher cathodic potentials under the HER regime. However, the GR film can be periodically reformed on the steel surface by electrochemical cycling in the N₂ environment in the same electrolyte at a pH of 9.5 in a single cell compartment.

Although the technology has been described and illustrated with respect to exemplary embodiments thereof, it should be understood by those skilled in the art that the foregoing and various other changes, omissions and additions may be made therein and thereto, without departing from the spirit and scope of the present invention.

What is claimed is:

1. A system for converting CO₂ to one or more multicarbon products, comprising:
a container comprising a first volume adapted to hold a first electrolyte;
a first electrode, comprising a quantity of a green rust material positioned in the container so that the green rust material is in contact with the first electrolyte;
a second electrode arranged in the container to form, together with the first electrode, electrical terminals of an electrolytic cell; and
a source of CO₂ coupled to the container and adapted to supply CO₂ to the first volume.

2. The system of claim 1, further comprising a source of potential connected to the first and second electrodes and adapted to apply a potential difference across the electrodes.

3. The system of claim 1, wherein the second electrode comprises platinum.

4. The system of claim 1, wherein the first electrolyte comprises KHCO₃.

5. The system of claim 1, wherein the source of CO₂ is adapted to provide a continuous supply of CO₂ to the container.

6. The system of claim 1, further comprising a proton exchange membrane disposed in the container and separating the first volume from a second volume in which the second electrode is arranged.

7. The system of claim 2, wherein the source of potential is adapted to apply a voltage of between about −0.15 V and about −0.35 V across the first and second electrodes.

8. The system of claim 1, wherein the green rust material comprises at least one crystalline layer and wherein the at least one crystalline layer comprises Fe^{II}—OH and Fe^{III}—OH.

9. The system of claim 8, wherein the ratio of Fe^{II}—OH to Fe^{III}—OH in the green rust material is between about 0.5 and about 1.0.

10. The system of claim 8, wherein, as synthesized and prior to exposure to air, the at least one crystalline layer consists essentially of Fe^{II}—OH and Fe^{III}—OH.

11. A method for converting CO₂ to one or more multicarbon products, comprising the steps of:
supplying CO₂ to an electrolyte;
contacting a first electrode comprising a quantity of a green rust material with the electrolyte; and
removing the electrolyte after contacting the first electrode for a contact period.

12. The method of claim 11, further comprising the steps of:
contacting a second electrode with the electrolyte; and
separating the first electrode from the second electrode with a proton exchange membrane.

13. The method of claim 12, further comprising the step of applying a potential difference across the first and second electrodes.

14. The method of claim 13, wherein the step of applying a potential difference comprises applying a voltage of between about −0.15 V and about −0.35 V across the first and second electrodes.

15. The method of claim 11, wherein the green rust material comprises at least one crystalline layer and wherein the at least one crystalline layer comprises Fe^{II}—OH and Fe^{III}—OH.

16. The method of claim 15, wherein the ratio of Fe^{II}—OH to Fe^{III}—OH in the green rust material is between about 0.5 and 1.0.

17. The method of claim 11, wherein the electrolyte comprises KHCO₃.

18. The method of claim 12, wherein the second electrode comprises platinum.

19. The method of claim 11, wherein the contact period is between about 10 minutes and 60 minutes.

20. The method of claim 11, further comprising the step of forming the green rust material, comprising the steps of:
supplying N₂ to a second electrolyte;
contacting the first electrode and a counter electrode with the second electrolyte; and
applying a potential difference across the first electrode and the counter electrode;
wherein the second electrolyte comprises NaHCO₃ adjusted to a pH of about 9.5 by adding NaOH.
